(19) United States
(12) Patent Application Publication
(10) Pub. No.: US 2017/0025842 A1
(43) Pub. Date: Jan. 26, 2017

(54) Method and apparatus for monitoring and controlling electrical energy consumption

(71) Applicant: Thomas L. Peterson, Fairfax Station, VA (US)

(72) Inventor: Thomas L. Peterson, Fairfax Station, VA (US)

(21) Appl. No.: 15/139,401

(22) Filed: Apr. 27, 2016

Related U.S. Application Data
(60) Provisional application No. 62/153,962, filed on Apr. 28, 2015.

(51) Int. Cl. H02H 3/00; G05B 15/02; H02H 3/04

(52) U.S. Cl. CPC H02H 3/00; H02H 3/04; G05B 15/02

(57) ABSTRACT

A method and apparatus for monitoring and controlling electrical energy consumption in an electrical circuit is provided. The monitoring device includes a sensor coupled to the electrical circuit for producing an electrical fault signal when a fault is detected in the circuit, a signal processing unit coupled to the fault sensor for improving the signal to noise ratio of the fault signal, a fault trigger condition register for storing at least one response action to be taken by the monitoring device when the fault condition is detected and a central processing unit (CPU) coupled to the signal processing unit and to the fault trigger condition register. In response to the fault signal, the CPU causes the monitoring device to take a response action.

### TECHNICAL FIELD

The present invention generally relates to the field of energy use and more particularly, is directed to a method and apparatus for monitoring and controlling electrical energy consumption.

### BACKGROUND

Since the dawn of the industrial revolution, electrical energy has been an indispensable worker in building the twenty-first century world that humankind enjoys today. From modern medicines to space age technologies, few of humanity's advances would have been possible without electrical energy. The importance of electrical energy is likely to continue for many generations to come.

The law of conservation of energy states that energy cannot be destroyed or created. It can only be changed from one form into another or be transferred from one object to another.

Energy in an electrical form is often the most convenient to distribute, control and use. For these reasons, electrical energy holds an important place in virtually every aspect of society. The state of a country's development and prosperity often is measured by its per capita consumption of electrical energy.

One characteristic of electrical energy is that it can be generated as direct current (DC) or alternating current (AC). A battery is an example of DC where electrical energy results from a chemical conversion process. A wind-driven generator is an example of AC where electrical energy results from the conversion of kinetic energy from the wind.

The first commercial electric power transmission systems were DC and transmitted current at the same voltage required by the load. Such systems suffered from significant I²R losses in the transmission lines in the form of heat as well as other technical challenges. The loses restricted the distance between the generation plants and their users to relatively short distances. The restricted distances, along with the need for DC at different voltage levels based on use, meant that many local generating plants and transmission systems were required for wide use of electrical energy, each plant being located relatively close to the point of use.

While I²R losses can be reduced by increasing the voltage level, it is difficult and inefficient to increase DC voltage to a level that will significantly reduce I²R losses over long distance transmission lines.

AC significantly mitigates many of the challenges associated with transmitting DC over long distance transmission lines. Unlike DC, AC voltage can easily be raised or lowered as needed. This important characteristic makes it possible for the bulk transmission of electrical energy over long distances as we know it today.

In North America, AC electric power is generated and delivered to customers using to two connected, but different systems. Power is generated in bulk by remotely located power plants and is transmitted at high voltage to local substations. Transmission at high voltage greatly reduces the I²R loses in the transmission lines. The increased voltage also reduces the current in the transmission lines and thus, the size of the conductors.

While the number of high-voltage DC systems are increasing due to advances in technology, the bulk of energy transmission today remains in AC form.

Substations are located near demand centers where the power will be used. The network of power lines which connect the generating plants and the substations are known in the art as “power transmission lines.” At the substations, the AC voltage level is lowered and is then distributed to customers. The network of power lines which connect the substations to users is known in the art as “power distribution lines.”

Power generating plants, transmission lines, substations and distribution lines are collectively known in North America as the national “power grid.”

The national power grid, however, is comprised of three regional grids: one in the East that serves the U.S. Eastern seaboard, Plains states and some Canadian provinces; another in the West that serves the U.S. Pacific coast, the Mountain states and other Canadian provinces; and another that serves the state of Texas. Connection between the regional power grids is limited in order to minimize the impact of a disruption in one regional grid from affecting the other regional grids. The structure of the power grid greatly improves the reliability of electrical power delivery to customers.

Efficient generation, transmission and distribution of electric power is directly related to another characteristic of electrical energy. Electrical energy is difficult to store in large quantities for long periods. While DC energy may be readily stored in relatively small quantities as, for example, as a charge on a battery or a capacitor, AC cannot be stored so easily.

In most cases, the storage of AC energy requires that it be converted to another form, such as DC energy, and then stored in that form. The DC energy must then be converted back to AC in many cases before it can be used. Each primary conversion process results in a secondary conversion of energy into an undesirable form, usually heat.

In practical terms, energy in the form of AC must be generated and delivered at the precise moment that it is needed. The inability to efficiently store large quantities of AC energy creates significant challenges to its efficient generation and distribution.

Electric power plants are very expensive to build, operate and maintain. They are designed to have enough generating capacity to meet maximum demand at any given time. However, the demand for electric power constantly varies. At any one time, demand depends on time of day, geographic location, season and many other factors. If customers are to be fully served at all times, the ideal power plant would be designed to meet worst case peak load demands. However, when present demand is below the peak generating capacity of the power plant, the excess energy generated is not used and cannot be stored for later use. Thus, the generation of excess energy is wasted and the cost of its production must be amortized among all of the power plant's customers. The environment suffers its share of the burden as well.

Power companies address varying demands for energy primarily in two ways.

First, generators that are not currently needed are taken off line; and

Second, when demand is higher than generation capacity, additional energy is purchased from other power companies and when demand is below capacity, the excess energy is sold to other power companies.

The power grid is designed so that connected power plants can export and import electrical energy to and from the power grid so long as voltage, frequency and phase are synchronized.

As the electric power industry has evolved from a heavily regulated industry to one that is less regulated, four distinct areas have emerged. These are (1) power generation, such as power plants; (2) bulk electric power transmission over high voltage line; (3) local power distribution to customers; and (4) power retailing. Retailing relates to the final sale of electrical energy to consumers.

In a fully regulated electric power market, there is only one main power company that owned all of the transmission and distribution infrastructure. The company operates by purchasing electricity from companies that generate it and then sell and distribute it to customers.

In a deregulated market, the company owns the transmission and distribution infrastructure but is only responsible for selling and distributing the electricity to end users. Deregulated markets permit electricity providers to compete and sell electricity directly to the consumers.

The goal of a deregulated market is to increase competition among suppliers, which leads to lower prices and allows consumers to shop for the best deal. However, deregulated electrical energy markets and the increasing popularity of alternative forms of electrical energy, such as solar and wind, have complicated the generation, distribution and use of electrical energy.

While solar and wind may be the only forms of energy available in some areas, they are increasing being used to reduce reliance on the power grid and the associated adverse impact on the environment that bulk generation of electrical energy causes.

In a typical residential solar installation for example, solar panels are placed to capture as mush sunlight as possible. The DC current produced by the solar panels is converted to AC and then used by the homeowner to reduce or eliminate the power taken from the power grid. The resulting benefit to the homeowner is a lower power utility cost and a contribution to preserving the environment.

When a solar or wind installation generates more energy than is needed by the consumer, the excess energy can often be sold to the power company.

While reducing the overall demand for bulk generated electricity, has important benefits, it causes other problems as well.

Power generating plants and the power grid must still be maintain for those times when wind or sunlight is not available. With less and less revenue due to the use of alternative sources of energy, power companies struggle to maintain the same level of infrastructure even when customers do not use the infrastructure all of the time.

It is for this reason that many public utility commissions allow power companies to charge those customers who use alternative sources of energy a fee to help subsidize the cost of bulk electricity generation and the power grid.

Currently, power companies sell electrical energy in kilowatt hour increments based on consumption. Due to deregulation, more concern over the environment, advances in alternative forms of energy, consumers are beginning to have many more options when buying electrical energy.

These options will include prepaying for monthly allotments of kilowatt hours and other services similar to service plans sold by cellular phone companies. Thus, it will be up to the consumer to control his or her electrical energy consumption.

Other options might include the power company agreeing to provide sufficient energy at a flat rate to maintain the temperate in a home or a room at a certain level for a season.

While there are many benefits to using electrical energy, there are also significant hazards. The primary hazards are electrical shock and fire. Electrical shock occurs when the body becomes part of the electric circuit by coming into contact with an energized electric circuit or metallic object.

A properly designed, installed and maintained electrical system is generally safe. Shocks and fires usually are the result of faulty equipment and/or deterioration in the electrical system. Properly designed equipment seldom fails spontaneously.

The conditions which lead to electrical equipment failure usually occur over time and announce impending failure in telltale ways. For example, as the electrical insulation in an appliance begins to deteriorate, the electrical current drawn by the appliance most often will increase correspondingly. Thus, increased current draw over time can indicate coming failure and serve as a warning of potential shock and fire risk.

Due to increasing environmental pressures, rising energy cost, more consumer awareness, improvements in technologies that bring alternative forms of energy within reach of the average homeowner and the ever-increasing need for clean electrical energy, there is a need in the art for a comprehensive solution for monitoring and controlling the consumption of electrical energy.

The present invention leverages the use of essential components of a safe electrical power system with respect to circuit overload and fault protection. In the typical electrical system, fuses and circuit breakers provide protection from circuit overloads while fault protection is provided by Arc Fault Circuit Interrupters (AFCI) and Ground Fault Circuit Interrupters (GFCI).

AFCI protection helps to prevent fires by detecting an unintended electrical arc and disconnecting the power source before the arc starts a fire. GFCI protection disconnects the power source when a current is detected flowing along an unintended path, such as through water or a person.

The present invention enhances the safety protections provided by circuit breakers and AFCI and GFCI devices while at the same time taking advantage of their ubiquitous presence in electrical systems to provide solutions to many of the current-day challenges to monitoring and controlling electrical energy consumption.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 is a block diagram of a smart circuit breaker in accordance with one embodiment of the present invention;

FIG. 2 is a flow chart illustrating the operation of the smart circuit breaker illustrated in FIG. 1;

FIG. 3 is a block diagram of a further embodiment of the present invention in the form of a smart electrical outlet;

FIGS. 4 and 5 is a flow chart illustrating the operation of the smart electrical outlet illustrated in FIG. 3;

FIG. 6 is a block diagram of another embodiment of a smart outlet having a plurality of branch circuit interrupters in accordance with the present invention;

FIG. 7 is a block diagram of another embodiment of a smart outlet, wherein a branch circuit interrupter is used to interrupt electrical power to electrical contacts;

FIG. 8 is a block diagram of another embodiment of a smart outlet implemented in a two phase system;

FIG. 9 is a block diagram of one embodiment of a remote control and display system for controlling and monitoring energy consumption and fault conditions in an electrical system in accordance with the present invention;

FIG. 10 is a block diagram of a module forming part of the system illustrated in FIG. 9;

FIG. 11 is a block diagram of one embodiment of a Master Control System in accordance with the present invention;

FIG. 12 is block diagram illustrating the integration of a smart breaker, smart outlet and Master Control system into an electrical power panel in accordance with the present inventions;

FIG. 13 is a block diagram of a solar array used as an alternative power source that incorporates a smart breaker in accordance with the present invention; and

FIG. 14 is a block diagram of a wind driven alternative power source that incorporates a smart breaker in accordance with the present invention.

### DESCRIPTION OF THE PREFERRED EMBODIMENT

A preferred embodiment of the present invention will be described with reference to the figures.

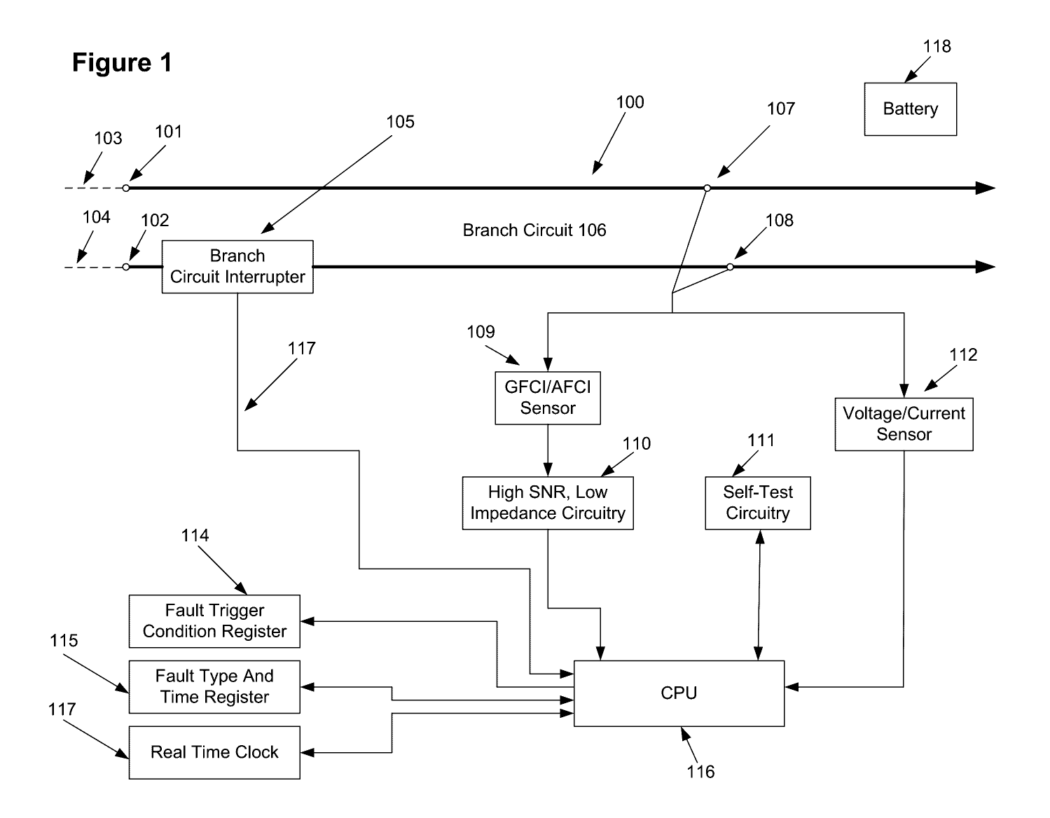

FIG. 1 is a block diagram of a smart circuit breaker 100 in accordance with one embodiment of the present invention. Breaker 100 can be fabricated in the physical size and profile of a conventional circuit breaker as used in an electrical power panel as is known in the prior art. Accordingly, breaker 100 can be used interchangeably with conventional circuit breakers as such breakers are known in the art.

Power terminals 101 and 102 of breaker 100 are coupled to, for example, neutral line 103 and phase line 104 of the main power line inside an electrical power panel. Phase line 104 is connected to branch circuit interrupter 105 which selectively breaks continuity of phase line 104 to branch circuit 106 when commanded to do so by signal 117 from CPU 116.

Interrupter 105 may be formed of mechanical components which are activated by a solenoid that can be triggered by an electrical signal as is known in the art. Interrupter 105 may also be formed of a solid-state device, such as a triac, as is also known in the art.

Breaker 100 further includes GFCI/AFCI sensor 109 which is connected to neutral line 103 and phase line 104 via interrupter 105 through terminals 107 and 108. Sensor 109 is configured to provide fault sense signals to CPU 116 via high signal-to-noise ratio (SNR), low impedance circuitry 110. SNR 110 improves the performance of GFCI and AFCI fault detection for breaker 100.

Voltage/current sensor 112 also is connected to neutral line 103 and phase line 104 via interrupter 105 through terminals 107 and 108. Sensor 112 and provides a voltage signal to CPU 116 indicating the voltage level of branch circuit 106 and the amount of current flowing through the branch circuit line. With voltage and current signals from voltage/current sensor 112 and fault signals from the GFCI/AFCI sensor 109, CPU 116 can identify faults in branch circuit 106, including overload faults, AFCI faults and GFCI faults. These faults are then used by CPU 116 to determine when, and under what conditions, interrupter 105 will be triggered to interrupt power to branch circuit 106.

When a fault occurs, CPU 116 stores the fault type and the time of its occurrence in fault type and time register 115. Breaker 100 can also can be programmed with the conditions upon which interrupter 105 will be triggered in response to detected faults. These conditions are stored in fault trigger condition register 114. Initially, default trigger conditions can be stored in register 114 and then changed as required.

Breaker 100 also includes a real time clock 117 which assist in keeping track of timed events, such as the time of day, time of a particular fault and elapsed time since a last fault.

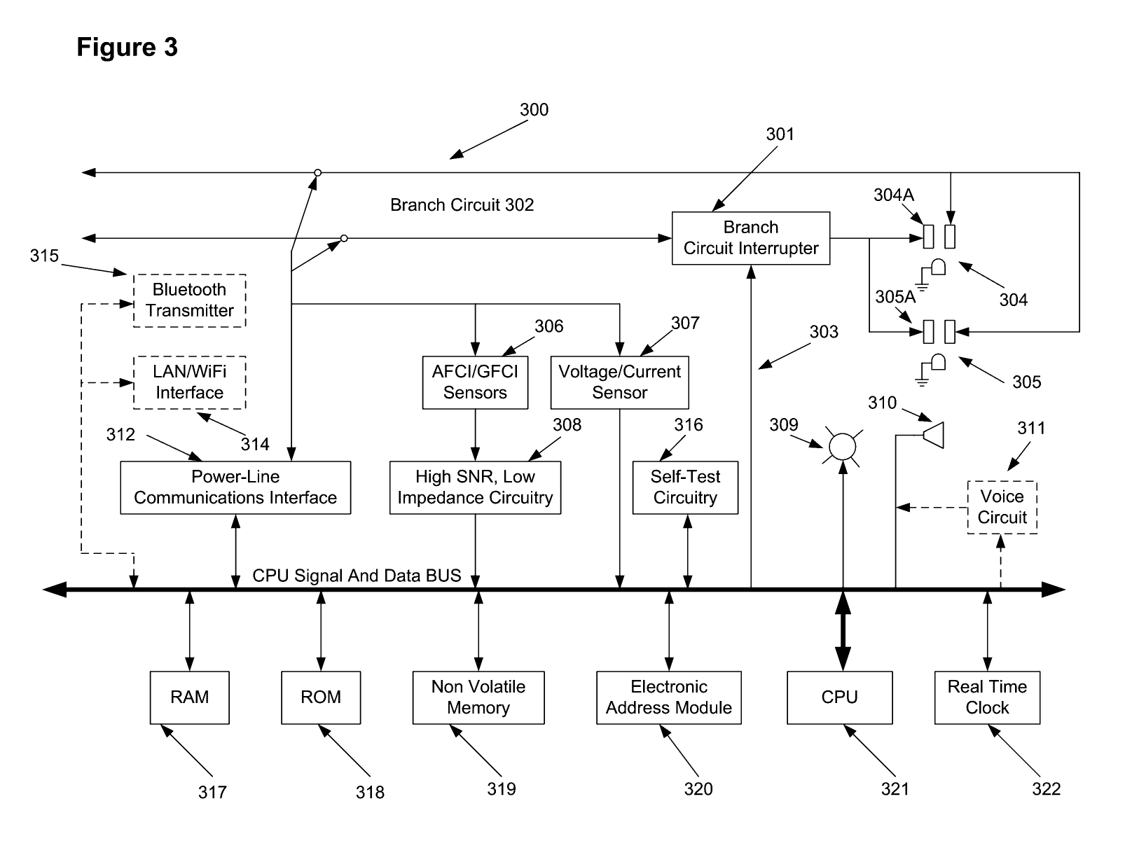

A more detailed description of the additional components, such as ROM and RAM, that allow CPU 116 to operate in the manner described with respect breaker 100 is set forth below with respect to FIG. 3.

Breaker 100 further includes self-test circuitry 111 that initiates a self-test of breaker 100 as one of ordinary skill in the art will know how to devise. The self-test can be initiated automatically when breaker 100 is installed in an electrical power panel or be manually initiated by a user pressing a test button.

Also shown in FIG. 1 is battery 118 which can be used to provide electrical power to breaker 100 when another power source is not available.

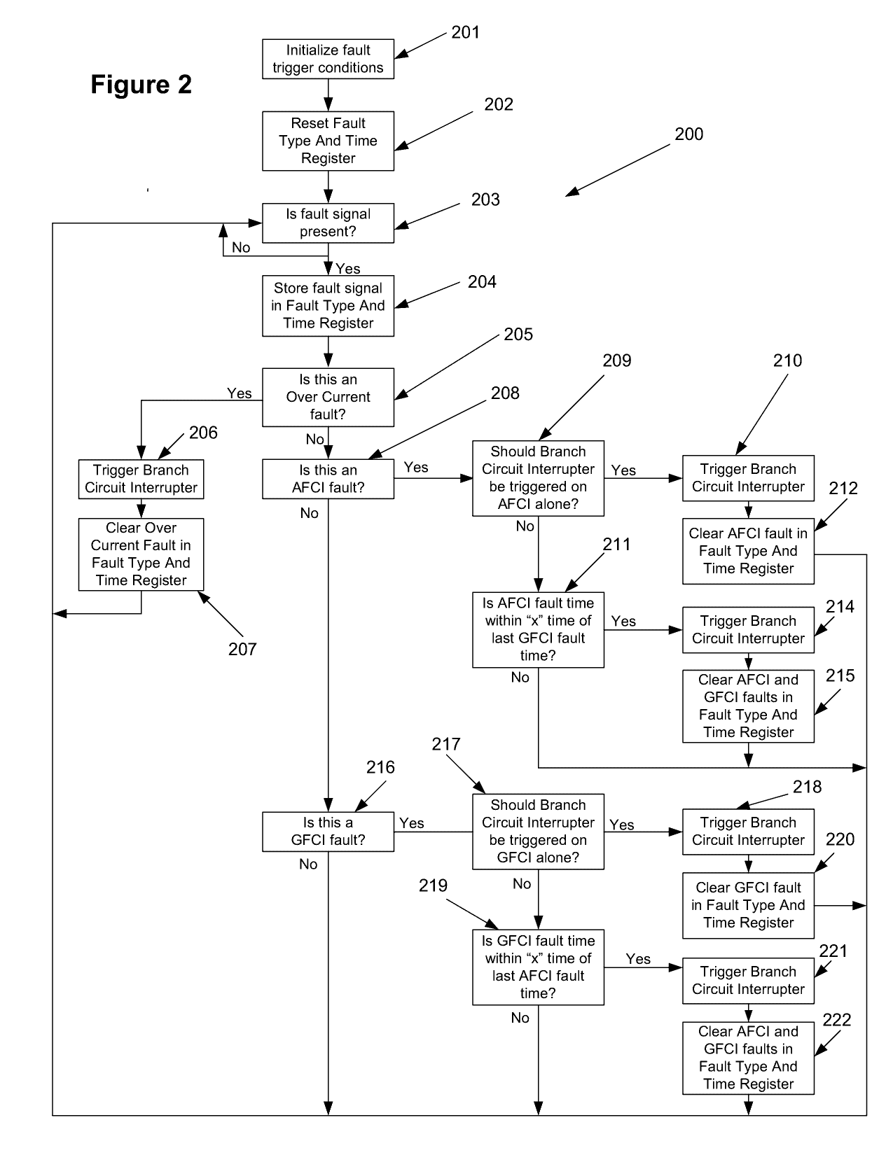

FIG. 2 is a flow chart 200 that illustrates the operation of breaker 100 as depicted FIG. 1.

In step 201, the fault trigger conditions for breaker 100 are initialized and stored in fault trigger condition register 114.

In step 202, fault type and time register 115 is reset to indicate no active or previous fault conditions.

In step 203, is decision is made whether a fault signal is present from GFCI/AFCI sensor 109 or from voltage/current sensor 112. If a fault signal is present, the process continues to step 204. If no fault signal is present, the process loops so that step 203 can make another decision whether a fault signal is present.

In step 204, the fault signal is stored in fault type and time register 115.

In step 205, a decision is made whether the fault signal is an over current fault. If yes, interrupter 205 is trigger to interrupt power to branch circuit 104 in step 206 and the over current fault condition previously stored in fault type and time register in step 204 is cleared in step 207. The process then loops back to step 203.

If step 205 determines that the fault condition is not an over current fault, a decision is made in step 208 whether the fault is an AFCI fault.

In the case of an AFCI fault, a decision is made in step 209 whether interrupter 105 should be triggered based solely on the presence of the AFCI fault condition. If yes, interrupter 105 is triggered in step 210, fault type and time registered 115 is cleared of the AFCI fault in step 212 and the process loops back to step 203.

If step 209 determines that interrupter 105 should not be triggered on the basis of the AFCI fault alone, a decision is made whether branch 105 should be triggered based on an addition fault condition. One example of an addition fault condition, as depicted in step 211, is that a prior GFCI fault occurred within a predetermined time “x” of the current AFCI fault condition. Other fault conditions can be used as well as those of ordinary skill in the art will understand.

If the conditions for triggering interrupter 105 are satisfied in step 211, interrupter 105 is triggered, fault type and time registered 115 is cleared of the AFCI and GFCI faults and the process loops back to step 203. If the conditions for triggering interrupter 105 are not satisfied in step 211, the process loops back to step 203.

If step 208 determines that the fault is not an AFCI fault, the process continues to step 216. In step 216, a decision is made whether the fault is a GFCI fault.

In the case of a GFCI fault, a decision is made in step 217 whether interrupter 105 should be triggered based solely on the presence of the GFCI fault condition. If yes, interrupter 105 is triggered in step 218, fault type and time registered 115 is cleared of the GFCI fault in step 220 and the process loops back to step 203.

If step 217 determines that interrupter 105 should not be triggered on the basis of the GFCI fault alone, a decision is made whether interrupter 105 should be triggered based on an addition fault condition. An example of an addition fault condition, as depicted in step 219, is that a prior AFCI fault occurred within a predetermined time “x” of the current GFCI fault condition. Other fault conditions can be used as well as those of ordinary skill in the art will understand.

If the conditions for triggering interrupter 105 are satisfied in step 219, interrupter 105 is triggered in step 221, fault type and time registered 115 is cleared of the AFCI and GFCI faults in step 222 and the process loops back to step 203. If the conditions for triggering interrupter 105 are not satisfied in step 219, the process then loops back to step 203.

FIG. 3 is a block diagram of a further embodiment of the present invention in the form of a smart electrical outlet 300.

Outlet 300 can be fabricated in the physical size and profile of a conventional electric wall outlet receptacle as is known in the prior art. Accordingly, outlet 300 can be used interchangeably with conventional wall outlets as such outlets are known in the art.

Outlet 300 includes branch circuit interrupter 301 which selectively breaks continuity of branch circuit 302 to outlet terminals 304A and 305A forming outlet receptacles 304 and 305.

Interrupter 301 may be formed of mechanical components which are activated by a solenoid that can be triggered by an electrical signal as is known in the art. Interrupter 301 may also be formed of a solid-state device, such as a triac, as also known in the art. In the present invention, the operation of interrupter 301 is controlled by a control signal 303 from CPU 321 in a manner described below.

Smart outlet 300 further comprises GFCI/AFCI sensors 306 and voltage/current sensor 307 which are coupled to branch circuit 302. GFCI/AFCI sensor 306 is configured to provide fault sense signals to CPU 321 over the CPU Signal And Data BUS (hereafter, “CPU BUS”) via High Signal-to-Noise ratio, Low Impedance Circuitry (SNR) 308. SNR 308 improves the performance of fault detection for smart outlet 300.

Voltage/current sensor 307 provides voltage and current signals to CPU 321 over the CPU BUS. With the voltage and current signals from voltage/current sensor 307 and fault sense signals from the GFCI/AFCI sensor 306, CPU 321 can identify faults, including branch circuit overload faults, AFCI faults and GFCI faults. If CPU 321 identifies a fault, one or more of three events can occur.

First: CPU 321 can output trigger signal 303 to interrupter 301 to break continuity of branch circuit 302 to outlet receptacles 304 and 305. CPU 321 can also trigger a visual indication of the fault condition such as by illuminating an LED light 309 or sounding an audio alarm through speaker 310 or other audio device. LED 309 can also be a multi-color device, each color indicating the type of fault condition. The audio alarm may also be in the form of a synthesized human voice from voice circuit 311 in accordance with the nature and severity of the fault.

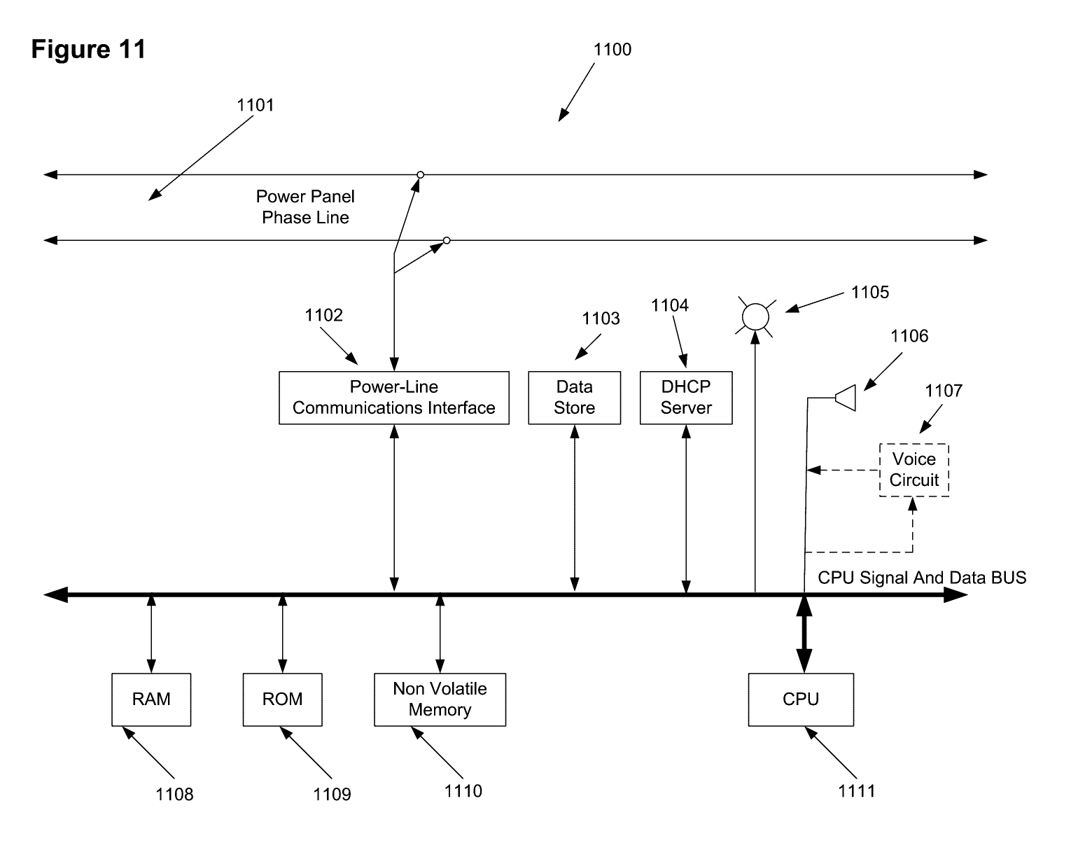

Second: Instead of triggering interrupter 301 directly to break the continuity of branch circuit 302 to outlet receptacles 304 and 305, CPU 321 may cause all, or selected fault signals, to be send to the Master Control System illustrated in FIG. 11 via Power-Line Communications Interface 312 for processing and disposition.

Power-line communication (PLC) is a communications technology known in the art for carrying data on a conductor that is also used simultaneously for AC electric power transmission or electric power distribution to consumers. Alternative communications technologies may also be used, such as LAN/WiFi interface 314, or Bluetooth via Bluetooth Transmitter 315.

Third: CPU 321 may trigger interrupter 301 to break the continuity of branch circuit 302 to outlets 304 and 305 as well as send the fault signal to the Master Control System illustrated in FIG. 11.

Outlet 300 also includes self-test circuitry 316 coupled to CPU 321 via the CPU BUS. Self-test circuitry 316 enables test signals to be sent to and from the Master Control System via, for example, Power-Line Communications Interface 312 to test the overall functionality of outlet 300.

Self-test circuitry 316 includes a test button that can be pressed in order to initiate the self-test or a self-test may be initiated by the Master Control System.

CPU 321 is used for executing computer software instructions as is known in the art. In addition to the elements described above, CPU 321 is coupled to a number of other elements via the CPU BUS.

These elements include RAM 317 (Random Access Memory) which may be used to store computer software instructions, ROM 318 (Read Only Memory) which may also be used to store computer software instructions, and Non Volatile Memory 319 which may be used to store computer software instructions as well.

In one aspect of the present invention, the computer software instructions that are executed by CPU 321 are divided into two or more separate and distinct categories which are stored in RAM 317, ROM 318 and/or Non Volatile Memory 319.

For example, a basis set of low level operating instructions, known in the art as firmware, might be stored in, ROM 318. These low level rudimentary instructions provide the necessary instructions for how CPU 321 communicates with the elements of smart outlet 300. Such instructions are necessary for CPU 321 to perform any useful operations, regardless of the task being performed.

A higher level instructions set, often known in the art as “application software” operationally “sits” on top of the firmware instruction set and is used to perform specific tasks, such as receiving fault signals from AFCI/GFCI Sensors 306 and determining the particular fault condition. The application software, resides in Non Volatile Memory 319.

In executing the firmware and application software instructions sits, CPU 321 will often need to temporarily store data and intermediate calculations. Such data and intermediate calculations are stored in RAM 317.

As is known in the art, firmware is permanently stored in ROM and is not intended to be changed. Application software also persist in Non Volatile Memory and but can be changed and update as old features in the software are deprecated and new features are added. This allows outlet 300 to be “reprogrammed” as need or desired by the Master Control System via, for example, Power-Line Communications Interface 312.

Electronic Address Module 320 provides a unique electronic address for smart outlet 300. Thus, outlet 300 can be uniquely addressed by the Master Control System. The address stored in Electronic Address Module 320 is implemented as a unique series of numbers. An example of such an addressing scheme is an Internet Protocol address based on IPv4 or IPv6 as is known in the art. The address can also be static or a dynamic IP address.

Once assigned, a static IP address does not change. Thus, Electronic Address Module 320 can be assigned a static IP address at the time of manufacture of the smart outlet. Alternatively, the Master Control System can assign the smart outlet a dynamic IP addresses when the smart outlet is connected to branch circuit 302.

Outlet 300 also includes a real time clock 322 which assist in keeping track of timed events, such as the time of day, time of a particular fault and elapsed time since a last fault.

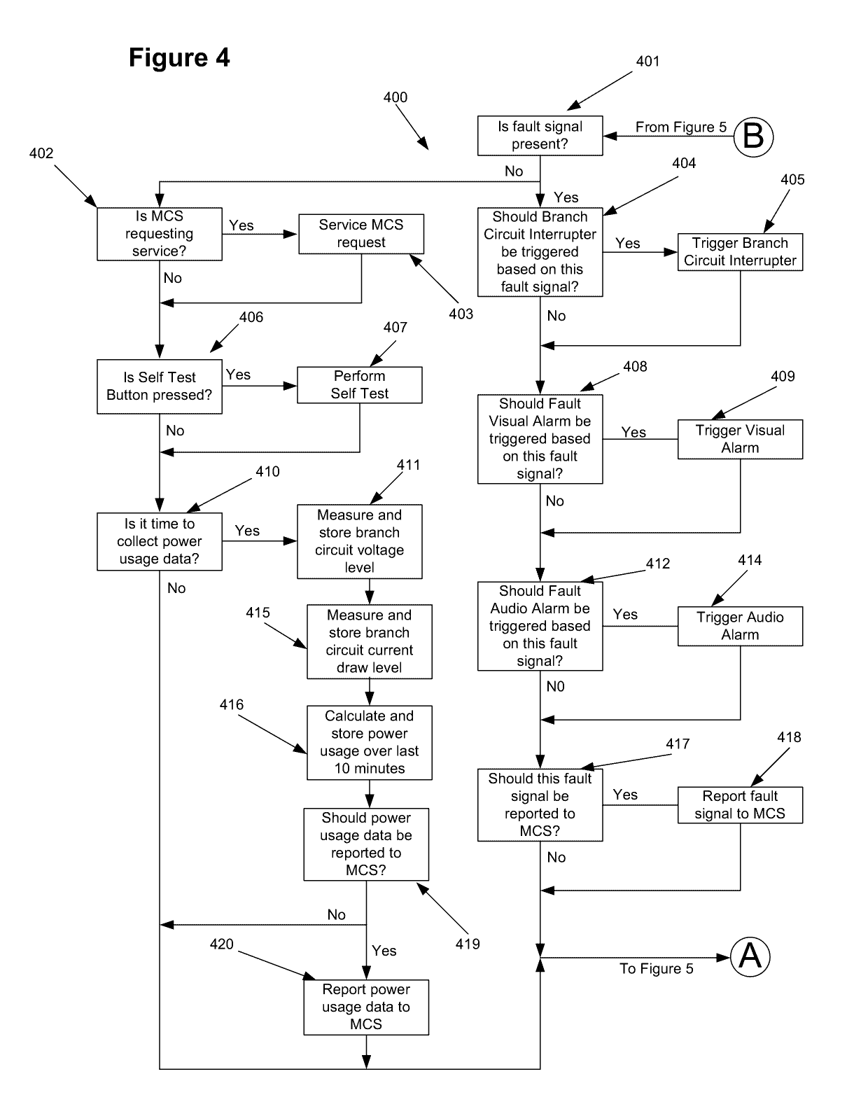

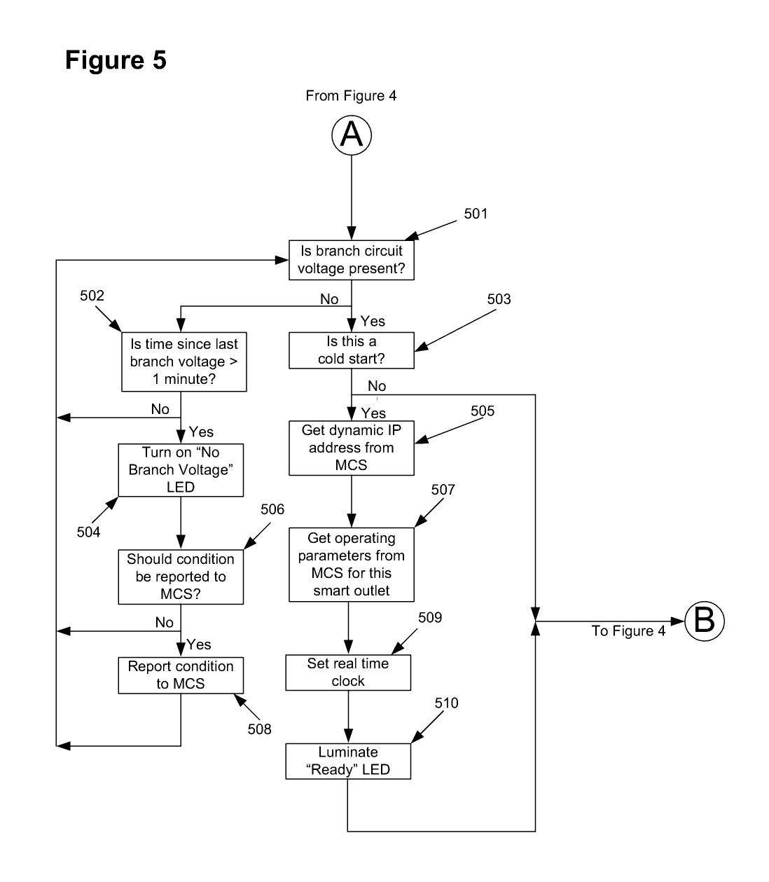

FIGS. 4 and 5 is a flow chart 400 that illustrates the operation of outlet 300 as depicted FIG. 3.

In step 401, a decision is made whether a fault signal is present. If yes, the process proceeds to step 404 where a decision is made whether interrupter 302 should be triggered based on this fault signal. If yes, interrupter 301 is triggered and the process continues to step 408. Otherwise, the process continues directly to step 408

In step 408, a decision is made whether a visual fault alarm should be triggered based on this fault. If yes, the visual alarm is triggered in step 409 and the process continues to step 412. Otherwise, the process continues directly to step 412.

In step 412, a decision is made whether an audio fault alarm should be triggered based on this fault. If yes, an audio alarm is triggered in step 414 and the process continues to step 417. Otherwise, the process continues directly to step 417.

In step 417, a decision is made whether the fault should be reported to the Master Control System. If yes, the fault is reported to the Master Control System and the process continues to step 501 in FIG. 5. Otherwise, the process continues directly to step 501 in FIG. 5.

In step 503, a decision is made whether a branch circuit voltage is present as indicated by the signal from voltage/current sensor 307 in FIG. 3. If yes, the process continues to step 503 where a decision is made whether this is a cold start as if outlet 300 is connected to branch circuit 302 for the first time. If yes, a dynamic IP address is obtained from the Master Control System in step 505. Otherwise, the process loops back to step 401 in FIG. 4. If a static IP has already been assigned to outlet 300, there will not be a need to obtain a dynamic IP in step 505

In step 507, the operating parameters for outlet 300 are obtained from the Master Control System and in step 509 real time clock 322 in FIG. 3 is set based on information, for example, from the Master Control System.

The process then proceeds to step 510 where a ready light, for example, a green light from LED light 309 in FIG. 3, is illuminated to indicate that outlet 300 is in a ready state.

The process then continues in step 401 in FIG. 4.

If in step 501, a determination is made that the no branch circuit voltage is present, the process continues to step 505.

In step 502, a decision is made whether the time since the last branch voltage was present is greater than, for example, one minute. If no, the process loops back to step 501. Otherwise, the process continues to step 504.

In step 504, a no branch voltage visual indication is provided by LED light 309, as for example, by lighting a red light not ready light. The process continues to step 506.

In step 506, a decision is made whether the status condition of outlet 300 should be reported to the Master Control System. If yes, the condition is reported in step 208 and the process loops back to step 501. Otherwise, the process directly loops back to step 501.

Returning now to FIG. 4, if the determination in step 401 is that a fault signal is not present, the process continues to step 402.

In step 402, a determination is made whether the Master Control System is requesting service from outlet 300. The requested service can be a request to communicate with outlet 300 to, for example, obtain the status of the fault conditions, provide new conditions under which interrupter 301 should be triggers, provide update firmware for the operation of CPU 321, etc.

If yes, the Master Control System is serviced in step 403 and the process continues to step 406. Otherwise, the process continues directly to step 406.

In step 406, a determination is made whether a self-test of outlet 300 should be performed. If yes, the self-test is performed in step 407 and the process continues to step 410.

In Step 410, a determination is made whether electrical power usage data should be collected. If yes, power usage data is determined and stored in steps 411, 415 and 416 by using sensor signals form voltage/current sensor 307 in FIG. 3.

In step 419, a decision is made whether the power usage date should be report to the Master Control System. If yes, the data is reported in step 402. Otherwise, the process loops back to step 501 in FIG. 5.

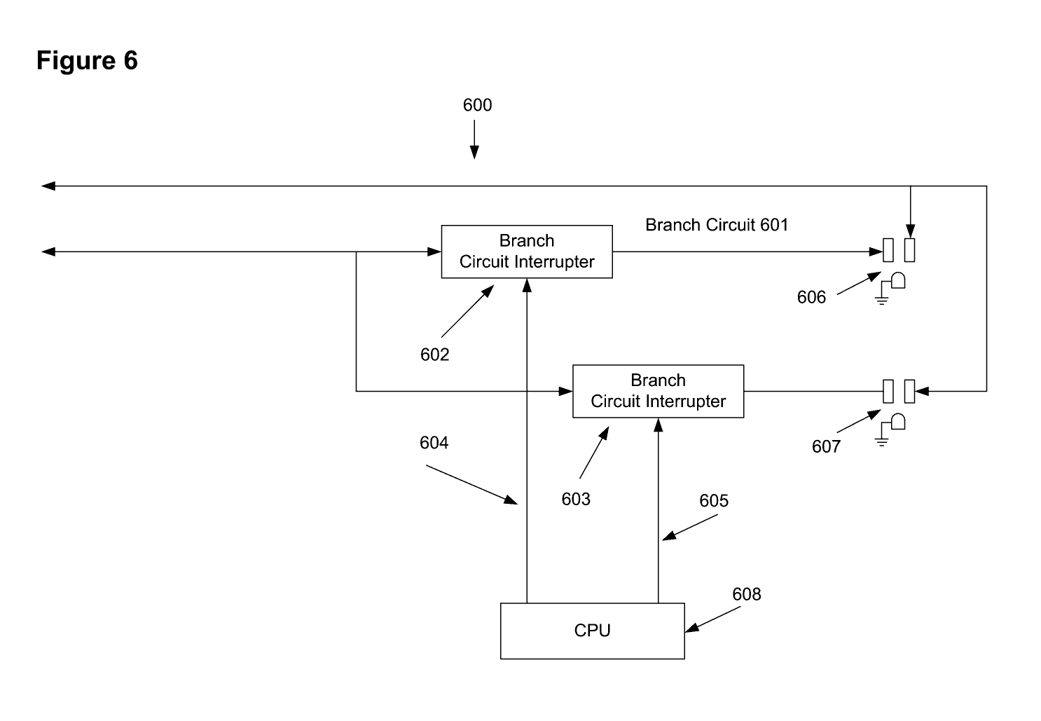

FIG. 6 is a block diagram of a another embodiment of a smart outlet 600 wherein first and second branch circuit interrupters 602 and 604 are used to interrupt electrical power from branch circuit 601 to receptacles 606 and 607 when commanded to do so by CPU 608 via control signals 604 and 605. CPU 608 operated in a manner similar to CPU 321 in FIG. 3.

Control signals 604 and 605 can be generated by CPU 608 independently based on the various fault conditions described with reference to FIG. 3 and the flowchart illustrated in FIGS. 4 and 5. Interrupters 602 and 603 may also be controlled by the Master Control System through CPU 608.

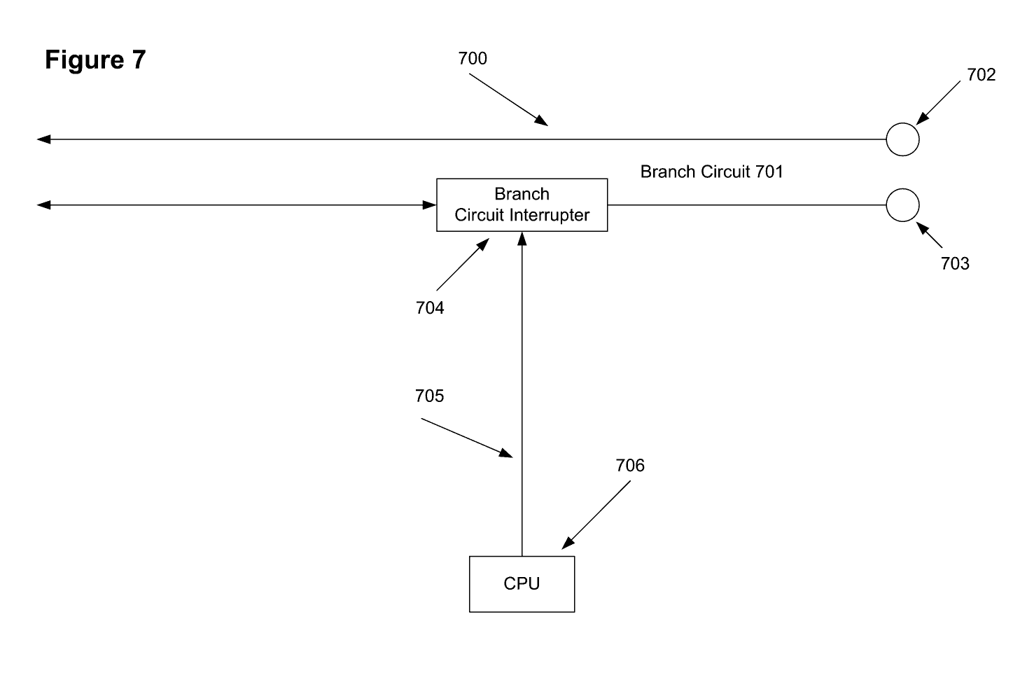

FIG. 7 is a block diagram of another embodiment of an smart outlet 700 wherein branch circuit interrupter 704 is used to interrupt electrical power from branch circuit 701 to electrical contacts 702 and 703 when commanded to do so by CPU 706 via control signal 705. CPU 706 operates in a manner similar to CPU 321 in FIG. 3.

Control signal 705 can be generated by CPU 706 based on the various fault conditions described with reference to FIGS. 1 and 3 and the flowchart illustrated in FIGS. 4 and 5. Thus, this embodiment of the present invention also includes a corresponding GFCI/AFCI sensor 109, high SNR, Low Impedance Circuitry 110, voltage/current sensor 112, self-test circuitry 111, fault trigger condition register 114, fault type and time register 115 and real time clock 117.

Contacts 702 and 703 may be connected to large appliances such as washing machines, dryers, refrigerators, heating and air conditioning systems and the like. The block diagram in FIG. 7 depicts a single phase system.

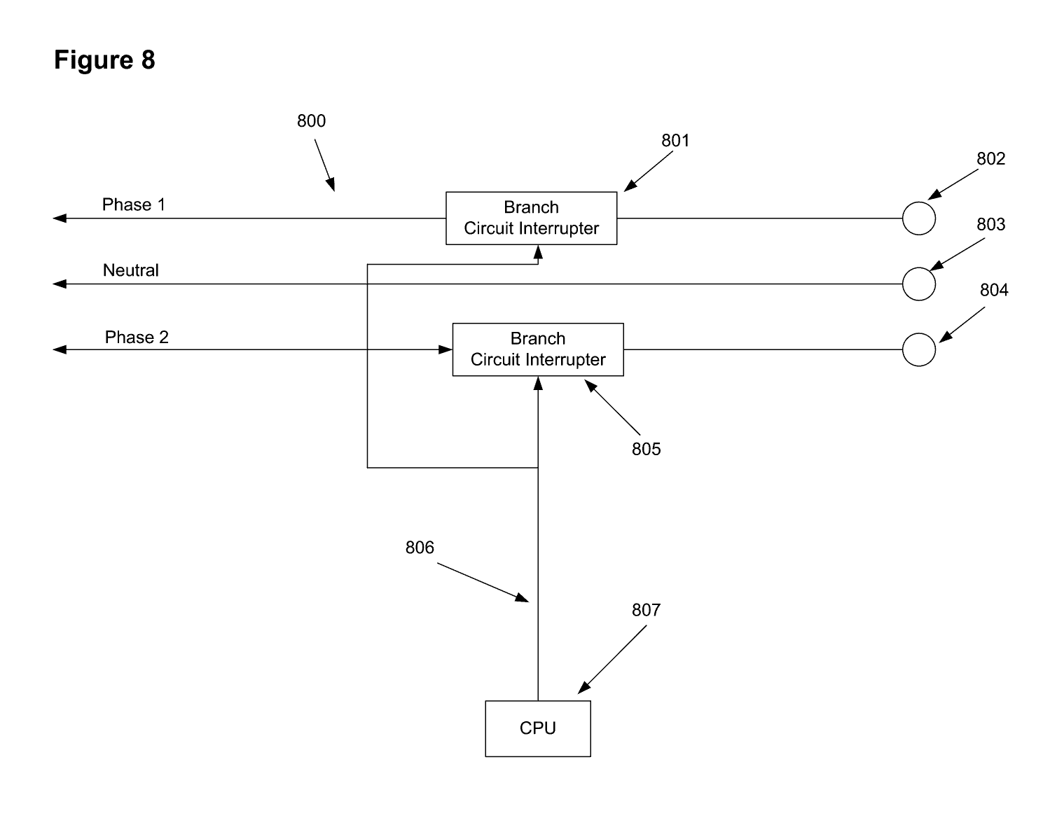

FIG. 8 is a block diagram of another embodiment of a smart outlet 800 implemented as a two phase system. In this embodiment, branch circuit interrupters 801 and 805 are used to interrupt electrical power from phase line 1 and 2 to electrical contacts 802 and 804 when commanded to do so by CPU 807 via control signal 806. CPU 807 is operated in a manner similar to CPU 321 in FIG. 3.

Control signal 806 can be generated by CPU 807 based on the various fault conditions described with reference to FIGS. 1 and 3 and the flowchart illustrated in FIGS. 4 and 5. Thus, this embodiment of the present inventions also includes a corresponding GFCI/AFCI sensor 109, high SNR, Low Impedance Circuitry 110, voltage/current sensor 112, self-test circuitry 111, fault trigger condition register 114, fault type and time register 115 and real time clock 117.

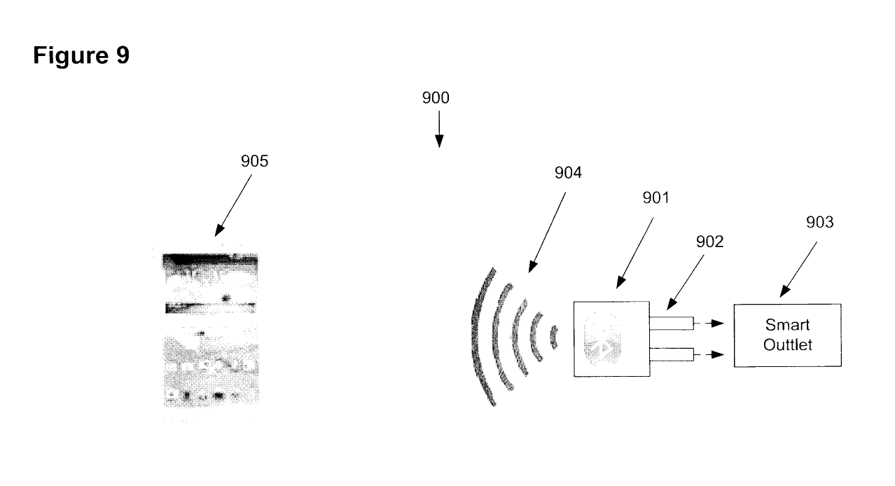

FIG. 9 is a block diagram of a remote control and display system for controlling and monitoring energy consumption and fault conditions reported by smart beakers and smart outlets in accordance with the present invention.

The system includes a module 901 having blades 902 which are adapted to plug into a conventional electrical outlet or smart outlet as illustrated in FIG. 3. Module 901 also includes a Bluetooth transmitter which communicates with smart device 905.

Smart device 905 can be a smartphone, tablet, laptop or desktop computer running a software application for controlling and monitoring smart outlets, such as outlet 300 illustrated in FIGS. 3, and 6-8.

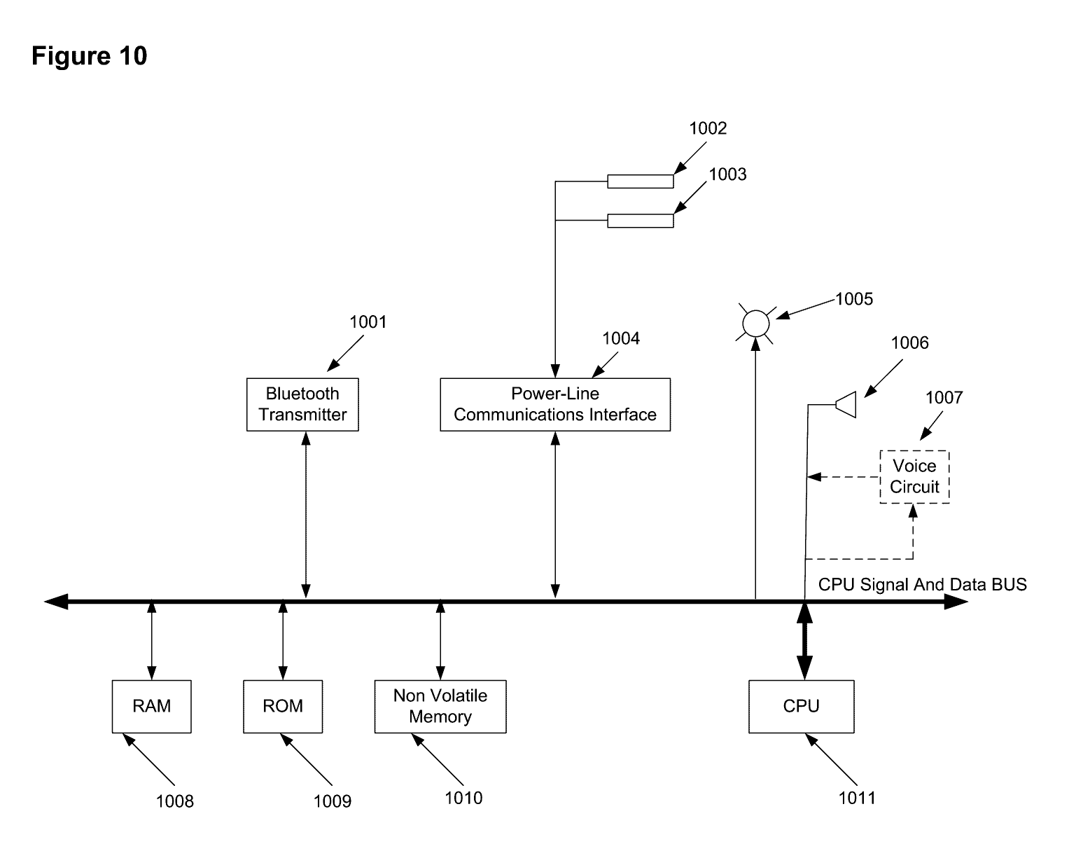

FIG. 10 is a block diagram of module 901 depicted in FIG. 9. Power-Line Communications Interface 1004 is couple to the branch circuit to with module 901 is connected via electrical blades 1002 and 1003. Blades 1002 and 1003 can plug into a conventional electrical wall outlet or to a smart outlet such as depicted in FIG. 3. A Bluetooth transmitter 1001 also is provides which allows control and display signals to be exchanged with smart device 905 shown in FIG. 9.

Also include in module 901 are status LED 1005 and audio alarm 1006 with register the operating status of module 901. A voice circuit 1007 may also be used to provide status information in the form of a synthesized human voice as those of ordinary skill in the art will know how to achieve.

The operation of module 901 is controlled by CPU 1011 which communicates with Bluetooth transmitter 1003, Power-Line Communications Interface 1004 and status indicators 1005 and 1006 via the a CPU signal and Data BUS.

Also coupled to CPU 1011 are RAM 1008, ROM 1009 and Non Volatile Memory 1010. These elements operate in a similar manner as RAM 317, ROM 318 and Non Volatile Memory 319 operate with respect to CPU 321 as described with respect to FIG. 3.

With the use of a smart device, module 901 allows a user to monitor and control the various smart breakers and outlets in an associated electrical system by communicating with the Master Control System.

FIG. 11 is a block diagram of one embodiment of a Master Control System (MCS) 1100 in accordance with the present invention. As MCS 1100 is able to communicate over the electrical wiring, it may operate from any location within an electrical power system.

For example, MCS 1100 may be fabricated in the physical size of a conventional circuit breaker and be plugged in to an electrical power panel, such as across one of the power phase lines as shown in FIG. 11. MCS 1100 may also be fabricated as an external module with electric power blades that can be plugged into a conventional electric wall outlet to establish an electrical connection to the electrical system.

The operation of MCS 1100 is controlled by CPU 1112 which communicates with smart devices, such smart breakers and smart outlets, over Power-Line Communications Interface 1102. Status LED 1105 and audio alarm 1106 provide information on the status of MSC 1100 and which are also controlled by CPU 1111 via CPU Signal And Data BUS.

Data Store 1103 is provided for storing electrical fault and power consumption information as might be reported by various smart devices in the electrical system.

DHCP server 1104 provides dynamic IP addresses to smart devices in the electrical that might require such as address as is known in the art.

Also coupled to CPU 1111 are RAM 1108, ROM 1109 and Non Volatile Memory 1110. These elements operate in a similar manner as RAM 317, ROM 318 and Non Volatile Memory 319 operate with respect to CPU 321 as described with respect to FIG. 3.

Module 901 allows a user to monitor and control the various smart breakers and outlets in an associated electrical system by communicating with the Master Control System.

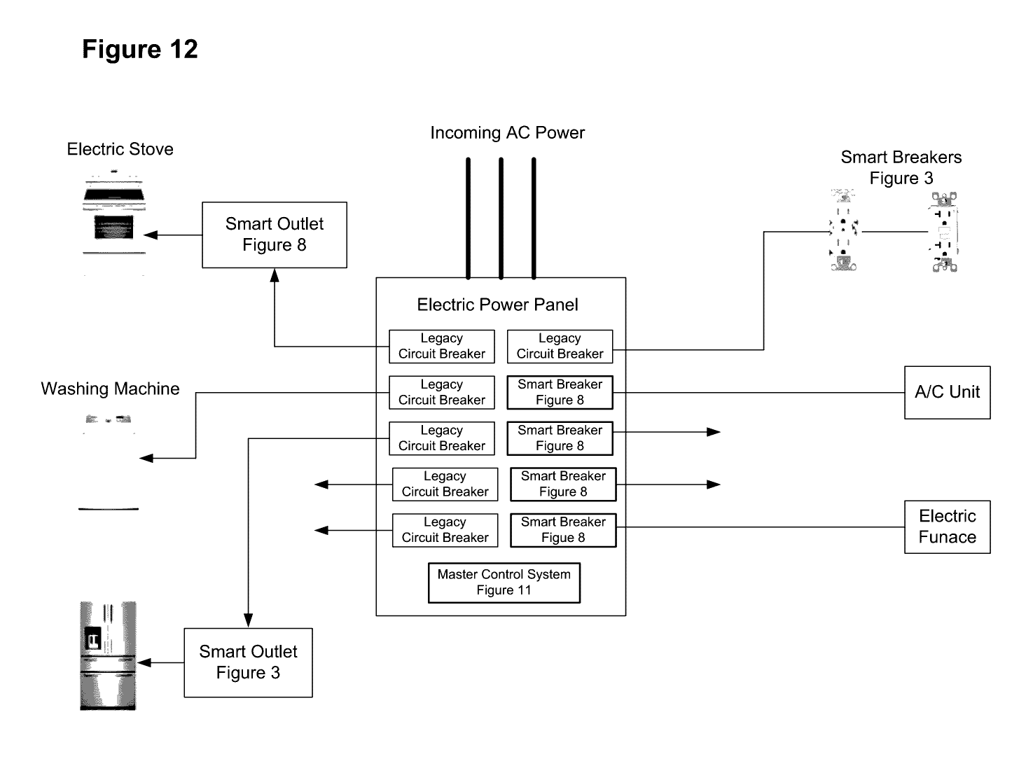

FIG. 12 is block diagram illustrating the integration of the smart breaker, smart outlet and Master Control system of the present invention into an electrical power panel and the branch circuit equipment that might be connected to the power panel.

As shown in FIG. 12, some branch circuits are protected by conventional legacy circuit breaker while others use the smart breaker and smart outlet of the present invention.

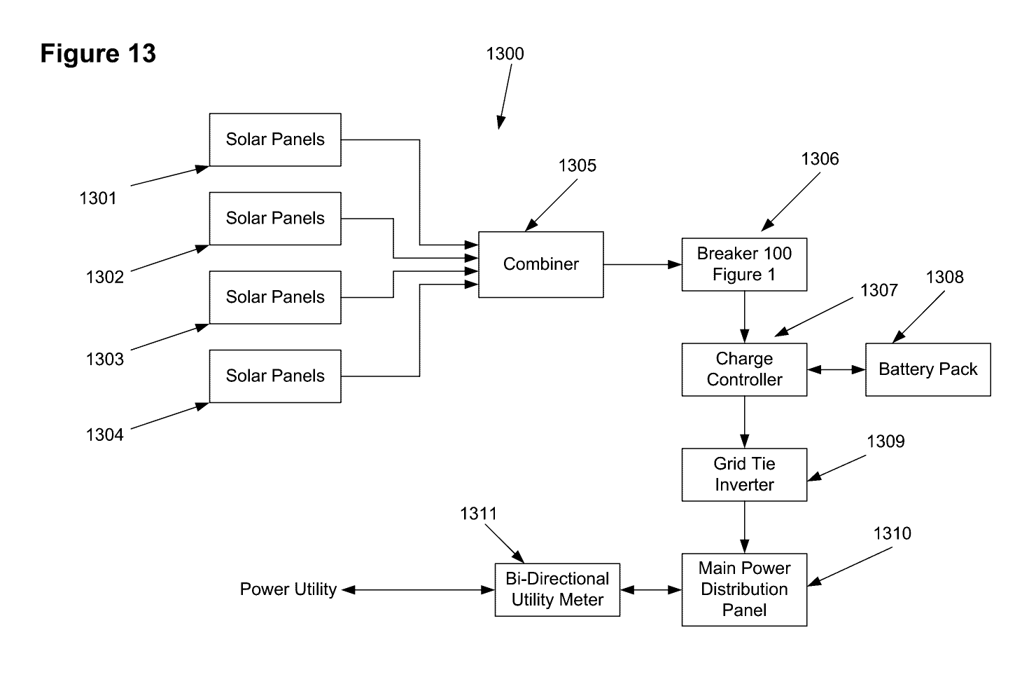

FIG. 13 is a block diagram of a solar array 1300 used to provide an alternative source of power.

The array includes solar panels 1301-104 as known in the art, combiner 1305 as known in the art, a smart breaker 1306 in accordance with FIG. 1 of the present invention, charge controller 1307 as known in the art, storage battery pack 1308 as known in the art, grid tie converter 1309 as known in the art, main power distribution panel 1310 as known in the art and bi-directional utility meter 1311 as known in the art.

Smart breaker 1308 monitors fault conditions and power generated by array 1300 and reports this information to the Master Control System. The Master Control System monitors power consumption within the electrical system by interrogating all of the smart breakers and smart outlets in the electrical system.

By doing so, an accurate account of the amount of power delivered by the solar array and by the power utility can be determined. Thus, cost setoffs can accurately be calculated when unneeded power generated by the solar array is sold to the power utility through bi-directional utility meter 1407.

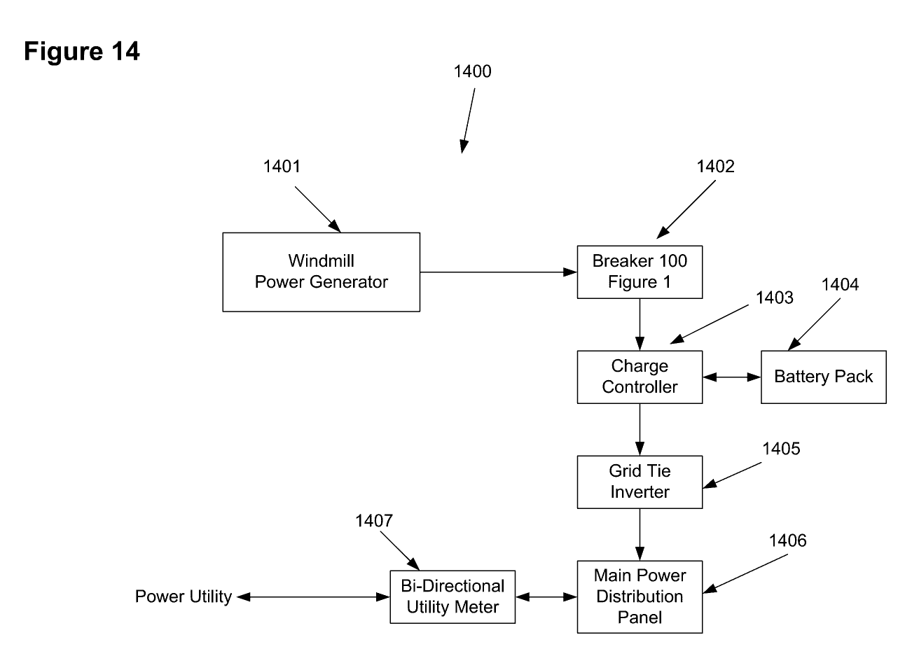

FIG. 14 is a block diagram of a wind driven alternative power source 1400. The elements of this system correspond to those described above with respect to the solar array system illustrated in FIG. 13.

While the foregoing specification teaches the principles of the present invention, with examples provided for the purpose of illustration, it will be appreciated by one skilled in the art from reading this disclosure that various changes in form and detail can be made without departing from the true scope of the invention.

I claim:

1. A monitoring device for monitoring an electrical circuit, said monitoring device comprising:
a fault sensor coupled to said electrical circuit for producing an electrical fault signal when a fault is detected in said electrical circuit;
a signal processing unit coupled to said fault sensor for improving the signal to noise ratio of said fault signal;
a fault trigger condition register for storing at least one response action to be taken by said monitoring device when said fault condition is detected;
a central processing unit (CPU) coupled to said signal processing unit and to said fault trigger condition register; and
wherein in response to said fault signal said CPU causes said monitoring device to take said response action.

2. The monitoring device of claim 1, wherein said fault sensor includes fault identification circuity for identifying the type of fault detected by said fault sensor from among a plurality of predetermined fault conditions.

3. The monitoring device of claim 2, wherein said plurality of predetermined fault types include current overload, AFCI, GFCI and AFCI/GFCI fault conditions.

4. The monitoring device of claim 3, further comprising a fault type register coupled to said CPU for storing the type of fault detected by said fault sensor.

5. The monitoring device of claim 4, further comprising a real time clock coupled to said CPU, wherein said CPU causes said fault type register to record the approximate time when said detected fault occurred.

6. The monitoring device of claim 3, wherein said fault trigger condition register stores a said response action for each of said plurality of predetermined fault types.

7. The monitoring device of claim 3, wherein said fault trigger condition register stores a said response action for a plurality of fault types occurring within a predetermined time of each other.

8. The monitoring device of claim 3, wherein said fault trigger condition register stores a said response action for at least one combination of a plurality of different fault types occurring within a predetermined time of each other.

9. The monitoring device of claim 1, further comprising a voltage/current sensor coupled to said electrical circuit and to said CPU for producing a voltage signal corresponding to the voltage level on said electrical circuit and a current signal corresponding to the current level flowing through said electrical circuit.

10. The monitoring device of claim 9, wherein when said voltage signal indicates the presence of a voltage level above or below a predetermined voltage level, said CPU produces a voltage fault signal and causes said monitoring device to take a predetermined response action.

11. The monitoring device of claim 9, wherein when said current signal indicates the presence of a current level above or below a predetermined current level, said CPU produces a current fault signal and causes said monitoring device to take a predetermined response action.

12. The monitoring device of claim 10, further comprising a fault trigger condition register coupled to said CPU for storing at least one response action to be taken by said monitoring device when said voltage fault signal is produced.

13. The monitoring device of claim 10, further comprising a fault trigger condition register coupled to said CPU for storing at least one response action to be taken by said monitoring device when said current fault signal is produced.

14. The monitoring device of claim 13, further comprising a fault type register coupled to said CPU for storing the type of fault detected by said voltage/current sensor.

15. The monitoring device of claim 14, further comprising a real time clock coupled to said CPU, wherein said CPU causes said fault type register to record the approximate time when said fault detected by said voltage/current sensor occurred.

16. The monitoring device of claim 1, further comprising self-test circuitry coupled to said CPU for causing said software to execute a predetermined diagnostic test routine of said monitoring device.

17. The monitoring device of claim 1, further comprises a circuit interrupter device serially connected in said electrical circuit and being adapted to selectively interrupt the flow of electrical current from said electrical circuit to a connected load, said circuit interrupter being controlled by said CPU, wherein said response action is said CPU controlling said circuit interrupter to interrupt the flow of current in said electrical circuit.

18. A circuit breaker for protecting an electrical circuit from fault conditions, said circuit breaker comprising:
a fault sensor coupled to said electrical circuit for producing an electrical fault signal when a fault is detected in said electrical circuit, said fault sensor including fault identification circuity for identifying the type of fault detected by said fault sensor from among a plurality of predetermined fault conditions;
a signal processing unit coupled to said fault sensor for improving the signal to noise ratio of said fault signal;
a fault trigger condition register for storing a response action to be taken for each of said faults detected by said fault sensor;
a fault type register coupled to said CPU for storing the type of fault detected by said fault sensor;
a central processing unit (CPU) coupled to said signal processing unit and to said fault trigger condition register;
a circuit interrupter device serially connected in said electrical circuit and being adapted to selectively interrupt the flow of electrical current from said electrical circuit to a connected load, said circuit interrupter being controlled by said CPU; and
wherein in response to said fault signal said CPU controlling said circuit interrupter to interrupt the flow of current in said electrical circuit.

19. The circuit breaker of claim 18, wherein said plurality of predetermined fault types include current overload, AFCI, GFCI and AFCI/GFCI fault conditions.

20. The circuit breaker of claim 18, further comprising a real time clock coupled to said CPU, wherein said CPU causes said fault type register to record the approximate time when said detected fault occurred.

21. The circuit breaker of claim 18, wherein said fault trigger condition register stores a said response action for a plurality of fault types occurring within a predetermined time of each other.

22. The circuit breaker of claim 18, wherein said fault trigger condition register stores a said response action for at least one combination of a plurality of different fault types occurring within a predetermined time of each other.

23. The circuit breaker of claim 18, further comprising a voltage/current sensor coupled to said electrical circuit and to said CPU for producing a voltage signal corresponding to the voltage level on said electrical circuit and a current signal corresponding to the current level flowing through said electrical circuit.

24. The circuit breaker of claim 23, wherein when said voltage signal indicates the presence of a voltage level above or below a predetermined voltage level, said CPU produces a voltage fault signal and causes said circuit breaker to take a predetermined response action.

25. The monitoring device of claim 24, wherein when said current signal indicates the presence of a current level above or below a predetermined current level, said CPU produces a current fault signal and causes said circuit breaker to take a predetermined response action.

26. The circuit breaker of claim 24, wherein said fault trigger condition register stores at least one response action to be taken by said circuit breaker when said voltage fault signal is produced.

27. The circuit breaker of claim 24, wherein said fault trigger condition register stores at least one response action to be taken by said circuit breaker when said current fault signal is produced.

28. The circuit breaker of claim 26, wherein said CPU causes said fault type register to store said voltage fault signal and the approximate time when said voltage fault signal occurred.

29. The circuit breaker of claim 27, wherein said CPU causes said fault type register to store said current fault signal and the approximate time when said current fault signal occurred.

30. The monitoring device of claim 1, further comprising a status indicator for providing status information.

31. The monitoring device of claim 30, wherein said status information indicates the operating state of said monitoring device.

32. The monitoring device of claim 30, wherein said status information indicates the presence or absence of said fault signal.

33. The monitoring device of claim 32, wherein said status indicator is a light emitting diode.

34. The monitoring device of claim 30, wherein said status indicator is a human voice.

35. The monitoring device of claim 1, further comprising a communications interface for said monitoring device to communicate with a remote device.

36. The monitoring device of claim 35, wherein said communications interface allows communications over a local area network.

37. The monitoring device of claim 35, wherein said communications interface allows communications over a local area network.

38. The monitoring device of claim 35, wherein said communications interface allows communications over a WiFi area network.

39. The monitoring device of claim 35, wherein said communications interface is a power-line communications interface.

40. The monitoring device of claim 35, wherein said communications interface allows communications using a Bluetooth protocol.

41. The monitoring device of claim 35, further comprising an electronic address module for providing a unique electronic address for said monitoring device.

42. The monitoring device of claim 41, wherein said electronic address is an Internet Protocol address.

43. The monitoring device of claim 1, wherein said monitoring device is adapted to monitor said electric circuit connected to a wall receptacle.

44. The monitoring device of claim 35, further including computer software for controlling the operation of said CPU, said computer software being updatable through said communications interface.
